(19) United States
(12) Patent Application Publication
(10) Pub. No.: US 2018/0128148 A1
(43) Pub. Date: May 10, 2018

(54) VEHICLE EXHAUST SYSTEM

(71) Applicant: GM GLOBAL TECHNOLOGY OPERATIONS LLC, Detroit, MI (US)

(72) Inventors: Guangzhi A. Zhao, Troy, MI (US); Richard Casper, Shelby Township, MI (US); Vincent J Tylutki, Livonia, MI (US)

(21) Appl. No.: 15/347,174

(22) Filed: Nov. 9, 2016

(51) Int. Cl. F01N 3/28; F01N 11/00; F01N 13/10; B01D 53/94; F01N 13/00

(52) U.S. Cl. CPC F01N 3/2892; F01N 11/007; F01N 13/10; F02D 41/1454; F01N 13/008; F01N 2550/02; B01D 53/94

(57) ABSTRACT

An exhaust system for a vehicle includes a catalytic converter, an exhaust manifold, an outlet sensor in addition to inlet and outlet pipes. The catalytic converter defines an inlet and an outlet. The exhaust manifold may be operatively configured to couple at least one vehicle combustion chamber to the inlet of the catalytic converter via the inlet pipe. The outlet pipe includes an internal portion and external portion. The outlet pipe may be affixed to the outlet of the catalytic converter. The internal portion of the outlet pipe defines at least one aperture upstream of the outlet sensor.

### TECHNICAL FIELD

This present disclosure relates generally to a vehicle exhaust system, and more particularly to an exhaust system which is optimized to better monitor and adjust the air fuel ratios in a vehicle engine.

### BACKGROUND

Internal combustion engines utilize feedback from Exhaust Gas Oxygen (EGO) sensors to maintain desired air-fuel ratio mixtures during combustion, at least under some conditions. The EGO sensors are part of the emissions control system and feeds data to the engine control module (ECM) to adjust the fuel to air ratio for the vehicle engine. Various types of EGO sensors may be used, such as linear type sensors, sometimes referred to as Universal Exhaust Gas Oxygen (UEGO) sensors, and switching type sensors such as Heated Exhaust Gas Oxygen (HEGO) and Exhaust Gas Oxygen (EGO) sensors, depending on whether a heater is included.

As is known, a vehicle engine burns gasoline in the presence of oxygen. It turns out that there is a particular ratio of air and gasoline that is “perfect.” and that ratio is 14.7.1. It is understood that different fuels may have different “perfect ratios”—the ratio depends on the amount of hydrogen and carbon found in a given amount of fuel. If there is less air than this perfect ratio, then there will be fuel left over after combustion. This is called a rich mixture. Rich mixtures are bad because the unburned fuel creates pollution. If there is more air than this perfect ratio, then there is excess oxygen. This is called a lean mixture. A lean mixture tends to produce more nitrogen-oxide pollutants, and, in some cases, it can cause poor performance and even engine damage.

Oxygen sensors are positioned in the exhaust pipe and can detect rich and lean mixtures in each of the engine cylinders. The mechanism in most sensors involves a chemical reaction that generates a voltage. The engine's computer looks at the voltage to determine if the mixture is rich or lean, and adjusts the amount of fuel entering the engine accordingly in order to make sure that all engine cylinders are operating correctly and under uniform conditions.

The reason why the engine needs the oxygen sensor is because the amount of oxygen that the engine can pull in depends on various things, such as the altitude, the temperature of the air, the temperature of the engine, the barometric pressure, the load on the engine, etc. In internal combustion engines equipped with an exhaust catalyst to reduce undesirable emissions, it has been found that modulation of the air-fuel ratio to rich and lean of stoichiometric conditions may also improve the efficiency of the catalyst under some conditions. One application of EGO sensors is to provide feedback upon which air-fuel ratios may be modulated. One prior approach involved modulating the air-fuel ratio using feedback from a Catalyst Monitor Sensor (CMS) such as a HEGO sensor to identify the stoichiometric conditions around which modulation was to take place.

Accordingly, it would be desirable in the industry to produce a vehicle exhaust system which is designed to provide accurate post O2 sensor data feedback to the engine control module in order to correctly modulate the air-fuel ratio.

### SUMMARY

Accordingly, the present disclosure provides an exhaust system for a vehicle which includes a catalytic converter, an exhaust manifold, an outlet sensor in addition to inlet and outlet pipes. The catalytic converter defines an inlet and an outlet. The exhaust manifold may be operatively configured to couple at least one vehicle combustion chamber to the inlet of the catalytic converter via the inlet pipe. The outlet pipe includes an internal portion and external portion. The outlet pipe may be affixed to the outlet of the catalytic converter. The internal portion of the outlet pipe defines at least one aperture upstream of the outlet sensor.

The present disclosure also contemplates the non-limiting example of an exhaust system having a catalytic converter, an outlet sensor, a mixing member disposed within the catalytic converter as well as inlet/outlet pipes. The exhaust manifold may operatively configured to couple a vehicle combustion chamber to the entry of the catalytic converter via a front pipe. The mixing member may be disposed within the catalytic converter proximate to the outlet of the catalytic converter. The mixing member may define at least one aperture which is operatively configured to disrupt the exhaust gas flow exiting the catalytic converter. The outlet pipe may be affixed to an outlet of the catalytic converter, and an outlet sensor may be affixed to the outlet pipe downstream of the mixing member.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description of preferred embodiments, and best mode, appended claims, and accompanying drawings in which:

FIG. 1 is a first schematic diagram of an exhaust system in accordance with various embodiments of the present disclosure.

FIG. 2 is a second schematic diagram of an exhaust system in accordance with various embodiments of the present disclosure.

FIG. 3 is a partial perspective diagram of an internal portion of an exhaust pipe in accordance with a first embodiment of the present disclosure.

FIG. 4 a partial perspective diagram of an internal portion of an exhaust pipe in accordance with a second embodiment of the present disclosure.

Like reference numerals refer to like parts throughout the description of several views of the drawings.

### DETAILED DESCRIPTION OF THE PRESENT DISCLOSURE

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

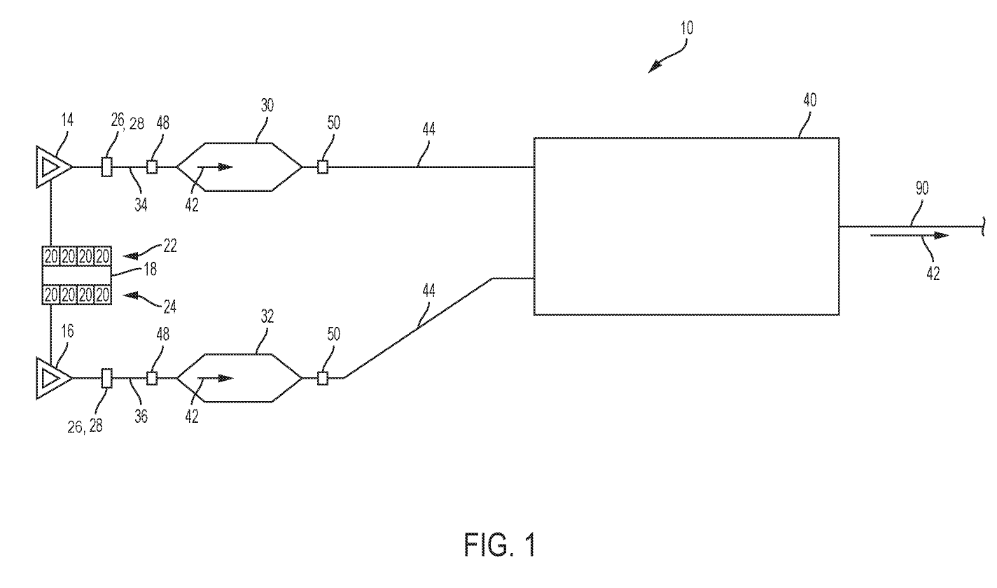

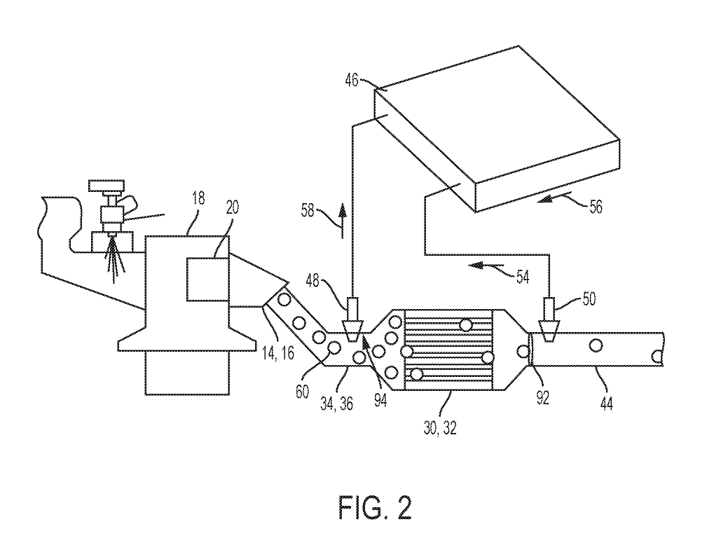

Referring now to FIGS. 1 and 2, schematic diagrams of an exhaust system 10 are shown in accordance with various embodiments of the present disclosure. An exhaust system 10 is connected to two banks 22, 24 of an engine 18 mounted on a vehicle. Each of those banks 22, 24 is connected to exhaust manifolds 14, 16 respectively to be communicated with a plurality of combustion chambers 20 provided at the respective banks 22, 24. As indicated, combustion engine 18 in FIGS. 1 and 2 may include a plurality of combustion chambers 20 which define the combustion spaces. In addition to the exhaust manifold 14, 16 which is coupled to the engine at the combustion chambers 20, the exhaust system 10 may, but not necessarily, include a mixing chamber (collector 26) or a downpipe 28 as part of the system.

The each combustion chamber 20 is connected to an exhaust manifold 14, 16, through which exhaust gases from the combustion reaction in the combustion chambers 20 are transferred to a catalytic converter 30, 32. As previously noted, the exhaust manifold 14, 16 may be coupled to the engine at 18 the combustion chambers 20. The exhaust system according to the present disclosure however is not restricted to combustion engines having a specific number of cylinders/chambers and can be used with various types of combustion engines.

Each of the exhaust manifolds 14, 16 is connected to corresponding front pipes, 34, 36 in which catalytic converters 30, 32 are provided for purifying the exhaust gas. A muffler 40 is provided downstream of the front pipe such that the respective portions of the front pipe 15, 16 may extend to the inside of the muffler 40. The muffler 40 is affixed to outlet pipe 44 where exhaust gases 42 are transmitted to the atmosphere.

In order to make sure that the vehicle engine 18 is provided the right mixture of air and fuel, an exhaust monitoring system 56 is implemented which includes an inlet oxygen sensor 48 as well as an outlet oxygen sensor 50. The inlet oxygen sensor 48 and/or outlet oxygen sensor 50 are responsible for keeping the air/fuel ratio of the mixture entering the engine 18 at the optimal level, which is approximately 14.7:1 or 14.7 parts of air to 1 part of fuel. When the inlet oxygen sensor 48 and/or outlet oxygen sensor 50 senses high level of oxygen content 60 (shown in FIG. 2), the engine control module (ECM) 46 assumes that the engine 18 is running lean (not enough fuel), so the ECM 46 adds fuel. When the level of oxygen in the exhaust becomes low, the ECM 46 assumes that the engine 18 is running rich (too much fuel) and reduces fuel supply.

The exhaust monitoring process is continuous. The ECM 46 and the engine 18 constantly cycles between slightly lean and slightly rich conditions to keep the air/fuel ratio at the optimum level. This process is called closed loop operation. With reference to FIG. 2, the ECM review of data from the inlet oxygen sensor voltage signal 58 and outlet oxygen sensor voltage signal 54 may demonstrate that the inlet/outlet oxygen sensors 48, 50 may be cycling somewhere between 0.2 Volts (Lean) and 0.9 Volts (Rich).

As shown in schematic FIGS. 1 and 2, an inlet oxygen sensor 48 may be installed in the exhaust manifold 16 or in the front exhaust pipe 34, 36 before the catalytic converter 30, 32. An outlet oxygen sensor 50 may be mounted in the outlet pipe 44 after the catalytic converter 30, 32 as shown in enlarged schematic view in FIG. 2. Accordingly, with reference back to FIG. 1, V6 and V8 vehicles may have at least four oxygen sensors 48, 50 shown in total. It is also understood that cars with a 4-cylinder engine have at least two oxygen sensors 48, 50. The engine computer (Engine Control Module or ECM 46) shown in FIG. 2 uses the output signal 58 from the inlet oxygen sensor 48 to adjust the air/fuel ratio by adding or subtracting fuel. The outlet oxygen sensor 50 transmits an output signal 54 is may also be used to monitor air/fuel ratio and/or the performance of the catalytic converter 30, 32.

The outlet oxygen sensor 50 measures the amount of oxygen 60 in the exhaust gases 42 coming out of the catalytic converter 30, 32. The signal 54 from the outlet oxygen sensor 50 is used to monitor the efficiency of the catalytic converter 30, 32 as well as measure the air fuel ratio in the exhaust gases 42. The ECM 46 constantly compares the output signals 54, 58 from the inlet and the outlet oxygen sensors 48, 50. Based on the two signals, the ECM 46 knows how well the catalytic converter 30, 32 and/or the vehicle engine 18 is performing. For example, the data from the first and second oxygen sensors 48, 50 may be used to measure the air fuel ratios from each combustion chamber 20 so as to ensure that each combustion chamber 20 is operating under uniform conditions.

In order to allow for the outlet oxygen sensor 50 to accurately read the composition of the exhaust gas 42 exiting the catalytic converter 30, 32, the present disclosure provides for an outlet pipe 44 having an internal portion 64 disposed inside the catalytic converter wherein an internal portion 64 of the outlet pipe 44 is disposed within the cavity 62 of the catalytic converter proximate to the outlet 92 of the catalytic converter 30, 32. The internal portion 64 defines at least one aperture 66 which is operatively configured to cause some swirling or turbulence in the exhaust gas flow 42 as the exhaust gas flow 42 exits the catalytic converter 30, 32 (just prior to the exhaust gas flow 42 passing the outlet oxygen sensor 50). Accordingly, the internal portion 64 with at least one aperture 66 allows for the exhaust system 10 via the outlet oxygen sensor 50 to accurately read the composition (various components) of the exhaust gas 42 given that the exhaust gas flow 42 components are mixed just prior to reaching the outlet oxygen sensor 50.

Therefore, as a result of the swirling or turbulence in the exhaust gas flow 42, the outlet oxygen sensor 50 which is disposed downstream of the catalytic converter 30, 32 and disposed downstream of the apertures 66 defined in the internal portion 64 may obtain a more accurate reading of the oxygen content levels in the exhaust gas flow 42. This arrangement eliminates the need to implement less effective (and more costly) saddles and bosses in the exhaust pipe due to the improved detection rate for the outlet oxygen sensor 50. The outlet oxygen sensor 50 then transmits an output data signal 54 to the ECM 46 so that the ECM 46 may deliver an optimized fuel and air mixture signal/instruction to the vehicle engine 18.

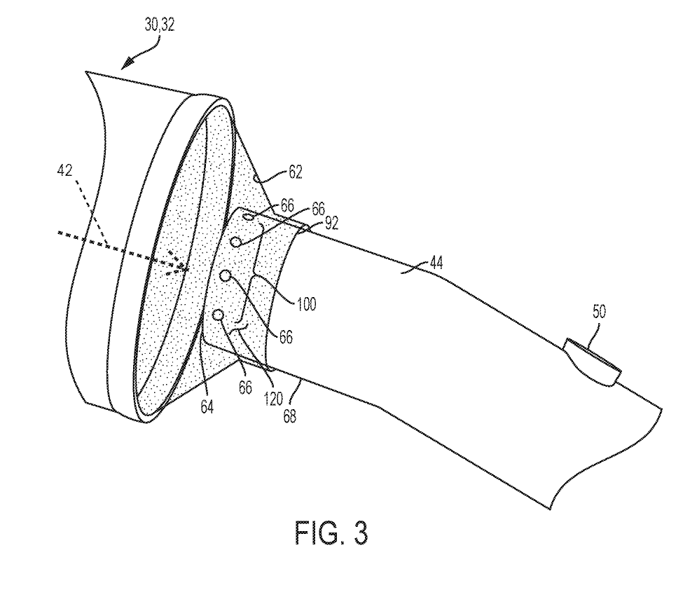

As shown in FIG. 3, the present disclosure contemplates an embodiment where at least one aperture may be defined in at least a sectioned-portion 100 of a circumferential surface 120 of the internal portion 64. It is understood that at least one aperture or a plurality of apertures 66 may be defined along the sectioned portion 100 of about 25% or less of a circumferential surface 120 of the internal portion 64. The plurality of apertures may be four apertures, more than four apertures or less than four apertures. While the apertures shown in FIG. 3 are circular, it is understood that the apertures may come in a variety of shapes—squares, circles, ovals, etc. In yet another non-limiting example, it is also understood that the exhaust system 10 of the present disclosure may include a plurality of apertures 66 of any shape where the apertures 66 are defined around the entire (100%) circumferential surface 120 of the internal portion 64.

Accordingly, the present disclosure provides an exhaust system for a vehicle which includes a catalytic converter, an exhaust manifold, an outlet sensor in addition to inlet and outlet pipes 34, 36, 44. The catalytic converter 30, 32 defines an inlet 92 and an outlet 94. The exhaust manifold 14, 16 may be operatively configured to couple at least one vehicle combustion chamber 20 to the inlet 92 of the catalytic converter via the inlet pipe 34, 36. The outlet pipe 44 includes an internal portion 64 and external portion 68. The outlet pipe 44 may be affixed to the outlet 92 of the catalytic converter 30, 32. The internal portion 64 of the outlet pipe 44 defines at least one aperture 66 upstream of the outlet sensor 50.

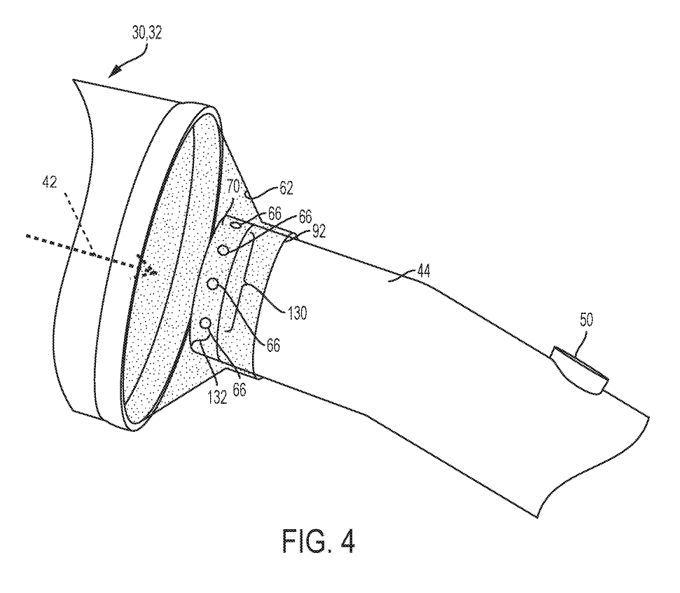

With reference to FIG. 4, the present disclosure also contemplates the non-limiting example of a second embodiment of the exhaust system 10 having a catalytic converter 30, 32, an outlet sensor 50, and a mixing member 70 disposed within the catalytic converter 30, 32 as well as inlet/outlet pipes 34, 36, 44. The mixing member may be affixed to the outlet pipe 44 or to the catalytic converter 30, 32. The exhaust manifold 16 may operatively configured to couple an engine combustion chamber 20 to the entry of the catalytic converter 30, 32 via at least a front pipe 34, 36. In the non-limiting example shown in FIG. 4, a mixing member 70 may be disposed within the catalytic converter proximate to the outlet 92 of the catalytic converter. It is also understood that the mixing member 70 may be disposed outside of the catalytic converter 30, 32 but upstream of the outlet sensor 50. Regardless of whether the mixing member 70 is located inside the catalytic converter 30, 32 or outside of the catalytic converter 30, 32, the mixing member 70 should be disposed upstream of the outlet sensor 50 in order to properly mix the exhaust gases 42 before the exhaust gases 42 travel to the outlet sensor 50.

Accordingly, the mixing member 70 may define at least one aperture 66 which is operatively configured to disrupt the exhaust gas flow 42 exiting the catalytic converter 30, 32. The outlet pipe 44 may, but not necessarily, be affixed to an outlet 92 of the catalytic converter 30, 32 via a welding process and an outlet sensor 50 may be affixed to the outlet pipe 44 downstream of the mixing member 70.

As shown in FIG. 4, the second embodiment of the present disclosure contemplates at least one aperture 66 defined in at least a sectioned-portion 100 of a circumferential surface 132 of the mixing member 70. The mixing member 70 may, but not necessarily, be in the form of an arced surface which corresponds to all or some of the circumference of the outlet 92 of the catalytic converter 30, 32. It is understood that at least one aperture or a plurality of apertures 66 may be defined along the sectioned portion 130 of about 25% or less of a circumferential surface 132 of the mixing member 70. The plurality of apertures may be four apertures 66, more than four apertures 66 or less than four apertures 66. While the apertures 66 shown in FIG. 4 are circular, it is understood that the apertures may come in a variety of shapes—squares, circles, ovals, etc. In yet another non-limiting example, it is also understood that the exhaust system 10 of the present disclosure may include a plurality of apertures 66 of any shape where the apertures 66 are defined around the entire (100%) circumferential surface 132 of the mixing member 70 in the event the mixing member encompasses the circumference of the outlet 92 of the catalytic converter 30, 32. It is understood that the mixing member 70, 72 may encompass a portion of the circumference of the outlet 92 of the catalytic converter 30, 32.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An exhaust system for a vehicle comprising:
a catalytic converter having an entry and an outlet;
an exhaust manifold operatively configured to couple a vehicle combustion chamber to the entry of the catalytic converter via a front pipe;
an outlet pipe affixed to the outlet of the catalytic converter, the outlet pipe having an internal portion and an external portion, the internal portion defining at least one aperture in an internal portion of the outlet pipe; and
a outlet sensor affixed to the outlet pipe and downstream of the internal portion of the outlet pipe.

2. The exhaust system of claim 1 further comprising an inlet sensor affixed to the front pipe upstream of the catalytic converter wherein the inlet sensor and the outlet sensor are in communication with an engine control module.

3. The exhaust system of claim 1 wherein the outlet sensor is operatively configured to determine the oxygen content of the exhaust gas flow and communicate with the engine control module.

4. The exhaust system of claim 1 wherein the internal portion of the outlet pipe is disposed within a cavity of the catalytic converter.

5. The exhaust system of claim 4 wherein the at least one aperture defined in the internal portion of the outlet pipe is operatively configured to disrupt the exhaust gas flow as the exhaust gas flow exits the catalytic converter.

6. The exhaust system of claim 5 wherein the at least one aperture is defined in at least a sectioned portion of a circumferential surface of the internal portion.

7. The exhaust system of claim 6 wherein the at least one aperture is defined in a sectioned portion of about 25% or less of a circumferential surface of the internal portion.

8. The exhaust system of claim 6 wherein the at least one aperture is a plurality of apertures formed about the entire circumferential surface of the internal portion.

9. The exhaust system of claim 7 wherein the at least one aperture is four aperture defined the sectioned portion.

10. An exhaust system for a vehicle comprising:
a catalytic converter having an entry and an outlet;
an exhaust manifold operatively configured to couple a vehicle combustion chamber to the entry of the catalytic converter via a front pipe;
a mixing member disposed within the catalytic converter proximate to the outlet of the catalytic converter, the mixing member defining at least one aperture;
an outlet pipe affixed to the outlet of the catalytic converter; and
an outlet sensor affixed to the outlet pipe and downstream of the mixing member.

11. The exhaust system of claim 10 further comprising an inlet sensor affixed to the front pipe wherein the inlet sensor and the outlet sensor are in communication with an engine control module.

12. The exhaust system of claim 10 wherein the outlet sensor is operatively configured to determine the oxygen content of the exhaust gas flow and communicate with the engine control module.

13. The exhaust system of claim 10 wherein the at least one aperture defined in mixing member is operatively configured to disrupt the exhaust gas flow as the exhaust gas flow exits the catalytic converter.

14. The exhaust system of claim 13 wherein the at least one aperture is defined about at least a sectioned portion of a circumferential surface of the mixing member.

15. The exhaust system of claim 14 wherein the at least one aperture is defined in a sectioned portion of about 25% or less of a circumferential surface of the mixing member.

16. The exhaust system of claim 13 wherein the at least one aperture is a plurality of apertures formed about the entire circumferential surface of the mixing member.

17. The exhaust system of claim 15 wherein the at least one aperture is four apertures defined in the sectioned portion.
